(19) United States
(12) Patent Application Publication
(10) Pub. No.: US 2012/0079754 A1
(43) Pub. Date: Apr. 5, 2012

(54) Mechanical Device to Replicate the Ripping Motion Utilized in Fishing

(76) Inventor: Jon J. Walko, Mountaintop, PA (US)

(21) Appl. No.: 13/249,324

(22) Filed: Sep. 30, 2011

Related U.S. Application Data
(60) Provisional application No. 61/389,383, filed on Oct. 4, 2010.

(51) Int. Cl. A01K 97/00; A01K 99/00

(52) U.S. Cl. 43/4.5; 43/26.1

(57) ABSTRACT

The present invention relates to a mechanical device that replicates the repetitive motion utilized by fishermen in a process known as “ripping”. The ripping process is replicated by use of a mechanical device that rapidly moves heavy fishing line about two feet in the horizontal direction in order to lure walleye to strike at a lure or baited hook. When a walleye strikes the lure, the force-actuated quick-release mechanism releases the line and the line is then completely controlled and attached to the fishing rod.

### CROSS REFERENCE TO RELATED APPLICATIONS

This Non-Provisional patent application claims priority based on Provisional Patent Application 61/389,383.

### FEDERAL RESEARCH STATEMENT

None

### BACKGROUND OF THE INVENTION

The present invention relates to an integrated mechanical device that replicates the repetitive motion utilized by fishermen in a process known as “ripping”. Ripping is a process used by walleye fishermen primarily in the cold lakes in the northeast United States and Canada. Walleye fishermen generally use heavy lead core fishing line while fishing for walleye. Over the years, walleye fishermen have determined that the optimum method for attracting walleye is to place bait on a hook or use a lure, let the hook or lure drop to close to the bottom of the lake, and then swiftly pull the line by hand (i.e. the “ripping” motion) in a horizontal or nearly horizontal motion in order to simulate the movement of small fish near the lake bottom. Walleye fisherman can stand in their boats for hours performing the ripping function manually. Along with being a physically tiring process, this can lead to severe stress on shoulders and arms and even lead to significant bodily damage over time.

The instant invention eliminates the need to “rip” heavy fishing line manually and instead presents a simple mechanical device that performs the ripping function at variable speeds and with varying time delays. While the ripping mechanism disclosed herein is primarily applicable to walleye fishing, it is also applicable to other types of fishing. In the interests of brevity, the instant invention is described in the context of walleye fishing with the implicit understanding that it is also applicable to many other types of fishing.

### DESCRIPTION OF THE PRIOR ART

There is precious little prior art that teaches anything close to the instant invention. There are some devices that replicate a manual “jerking” motion, but this is essentially a vertical motion and is designed to assist in the raising of a fish to the surface once it has been hooked. The instant device is designed to attract fish. Applicant has tested his prototype of this invention in lakes in Upper New York State. The interest that the device has garnered is indicative of the fact that there is nothing else close to it on the market.

### SUMMARY OF THE INVENTION

The present invention relates to a mechanical device that replicates the repetitive motion utilized by fishermen in a process known as “ripping”

The major components of this invention are: (a) a small electric motor and associated power cord, (b) a controller that controls the speed and delay time of the mechanism, (c) an armature attached to the shaft of the electric motor, (d) a mechanism for attaching heavy lead core fishing line to the armature, (e) a housing to enclose the motor, controller and other sensitive electrical and electronic component, (f) a power cord extending attached to the motor and extending through the housing, (g) an adapter plate that allows the entire device to be attached to the gunnels of a boat or other type of vessel, and (h) a power source.

The device is operated in the following manner. The device is mounted on the gunnels of a boat. The power cord is connected to an external power source—typically a marine battery. A fishing pole with heavy lead core line and a lure or bait attached to the line is already in the water with the lure resting at or near the bottom. The vessel is generally trolling at low speed through the water. The fisherman then attaches his heavy lead core line to the force sensitive quick-release mechanism at the end of the armature. The device is energized and the fisherman sets the controls to determine how quickly and with what frequency the armature moves. The movement of the armature as the boat moves through the water causes the line and ultimately the lure to move quickly through the water thereby simulating the movement of small fish near the bottom of the lake. The walleye sees this movement and strikes at the lure. When the walleye strikes and engages the lure, the force-sensitive quick release mechanism disengages the line from the ripping device and the fishing line is controlled solely by the fishing rod. After the fish is hooked and brought to the surface, the lure or bait is redeployed and the ripping process starts anew for as long as the fisherman desires.

### BRIEF DESCRIPTION OF DRAWINGS

FIG. 1 is a frontal perspective view of the device 10 showing the controller mechanism 20, and the power cord 30.

FIG. 2 is a view of the device 10 attached to the gunnels of a boat. Also shown is the armature 50 which oscillates between the forward and rearward position, a force-actuated quick-release mechanism 120 attached to the end of the armature, and a pole receptacle 65 in which a fishing pole resides during operation of the ripping device.

FIG. 3 is a side overhead view of the device 10 attached to the gunnels of a boat actually in the water. Also shown is the armature 50 in the far forward position, a fishing pole 60 resting against the gunnels and the heavy lead core fishing line 70 with some slack attached to the armature 50.

FIG. 4 shows the internals of the device 10 including the internal cabling 110, control mechanism 90, and the power cord 105 running from the external power source to the electric motor 100.

FIG. 5 is a close-up view of the force-actuated quick-release mechanism 120 that is located at the end of the armature. Also shown are the spring mechanism 122 and compression plate 126 that hold the lead line to armature and the upper moment arm 124 of the release mechanism. In addition, the aperture or gap 128 that forms when the moment arm 124 is depressed is shown. The fishing line 70 is placed into the gap 128. When the moment arm 124 is released, the spring mechanism 122 engages the compression plate 126 and hold the fishing line 70 firmly in place.

### DETAILED DESCRIPTION OF THE INVENTION

The present invention relates to a mechanical device that replicates the manual and physically strenuous repetitive motion utilized by fishermen, in a process known as “ripping.” Ripping is a process used for extended periods of time (usually many hours) by walleye fishermen primarily in the cold lakes in the northeast United States and Canada. In general, walleye are preferentially found near the bottom of the cold lakes in the Northeast. Therefore, walleye fishermen generally use heavy lead core fishing line while fishing for walleye in order that the lure/bait will sink to the bottom.

Over the years, walleye fishermen have determined that the optimum method for attracting walleye is to place bait on a hook or use a lure, let the hook or lure drop to close to the bottom of the lake, and then swiftly pull the line forward by hand a distance of three or four feet (i.e. the “ripping” motion) in order to simulate the movement of small fish near the lake bottom. Walleye fisherman can stand in their boats for hours performing the ripping function manually. Along with being a physically tiring process, this repetitive ripping motion can lead to severe stress on shoulders and arms and even lead to significant bodily damage over time. The significant physical toll incurred by walleye fishermen has been a long-standing and frequent source of complaint among this group of hearty outdoorsmen. Applicant's awareness of this issue led him to address it and thereby develop a sophisticated electro-mechanical device to replicate the ripping process and essentially resolve the problem.

The instant invention eliminates the need to “rip” heavy fishing line manually and instead presents a sophisticated yet simple mechanical device that performs the ripping function at variable speeds and at variable frequencies. While the ripping mechanism disclosed herein is primarily applicable to walleye fishing, it is also applicable to other types of fishing. In the interest of brevity, the instant invention is described in the context of walleye fishing with the implicit understanding that it is also applicable to many other types of fishing.

The major components of this invention are: (a) a small electric motor and associated power cord, (b) a controller that controls the speed and delay time of the mechanism, (c) an armature made of a strong lightweight non-corrosive metal or composite that is attached to the shaft of the electric motor, (d) a force-actuated quick-release mechanism made of a strong lightweight non-corrosive metal or composite for attaching heavy lead core fishing line to the armature, (e) a housing to enclose the motor, controller and other sensitive electrical and electronic component, (f) a power cord attached to the motor and extending through the housing, (g) an adapter plate that allows the entire device to be attached to the gunnels of a boat or other type of vessel, and (h) a power source.

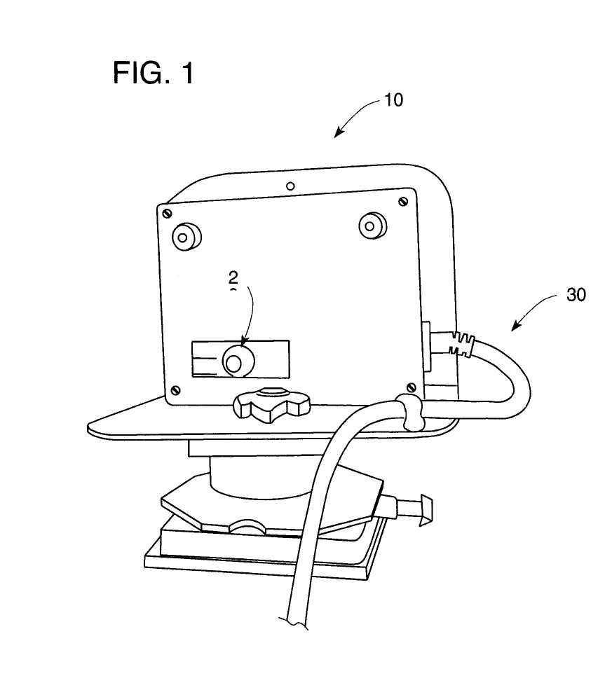

Referring to FIG. 1, a frontal perspective view of the device 10 is presented showing the controller mechanism 20, and the power cord 30. Note that the armature is not depicted in this FIG. 1—only the central part of the device is shown. In general, the central part of the device as is shown in this FIG. 1 is a fairly small object with dimensions between 6 and 12 inches in all three directions. The size of the device generally depends upon how large the electric motor is that drives the movement of the armature. While the instant invention generally contemplates a simple device wherein only one motor/armature apparatus is present, ripping devices with multiple electric motor/armature apparatuses could be produced and would be useful.

One of the key elements of this device is the controller 20 which controls the speed of the armature and the frequency of the simulated ripping motion. The controller regulates the speed of the motor/armature combination and also regulates the amount of cycles of the armature within a given period of time. The controller is generally an off the shelf device.

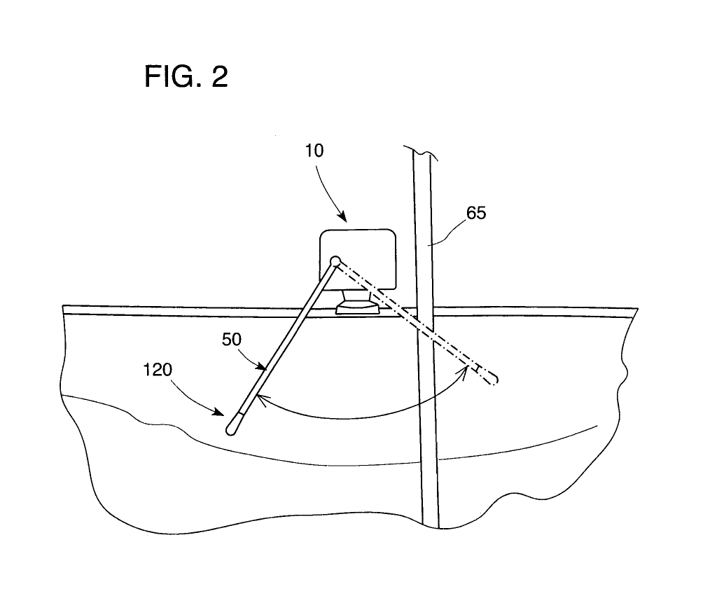

Referring to FIG. 2, a view of the device 10 attached to the gunnel of a boat is shown. Also shown is the armature 50 which oscillates between the rearward and forward positions, and a pole receptacle 65 in which a fishing pole resides during operation of the ripping device. FIG. 2 shows the armature in the rearward position as it would be at the beginning of the ripping cycle. The armature is fixedly attached at one end to the shaft emanating from the motor. At the other end of the armature, a force-actuated quick-release mechanism 120 is shown. Fishing line is attached to the force-actuated quick-release mechanism such that the line moves as the armature moves back and forth. When the motor engages the shaft, it rotates the shaft and the armature moves forward rapidly thereby replicating the manual ripping motion. Generally the shaft will rotate between 60 and 150 degrees to produce the ripping motion.

The motor shaft/armature assembly can either be continuous back and forth based on a reciprocating treatment of the assembly, or, alternatively, it can move only in the forward motion, disengage at the forward position, allow the armature to drift backward as the boat moves forward and then re-engage when the armature returns to the rearward position.

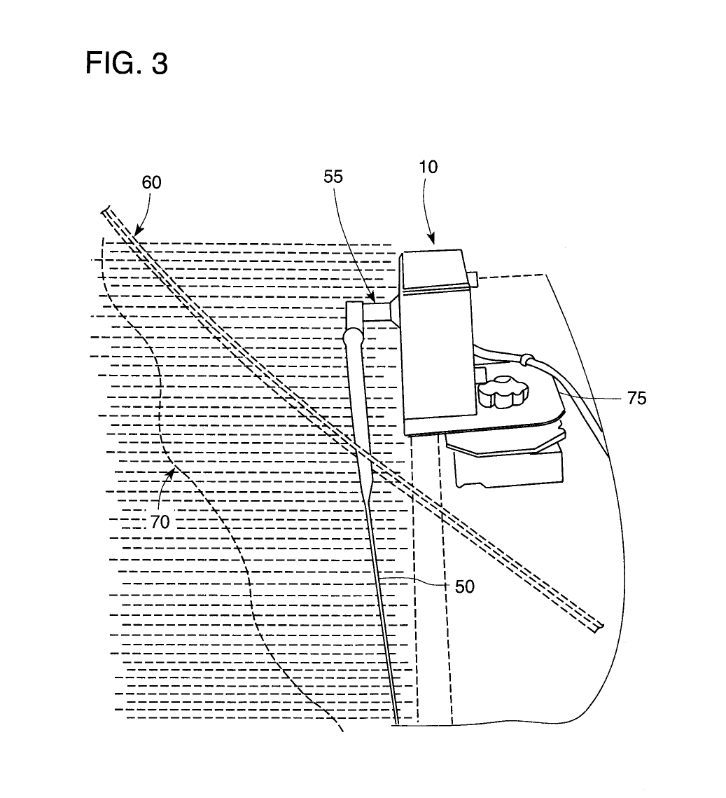

Referring to FIG. 3, a side overhead view of the device 10 attached to the gunnel of a boat actually in the water is shown. Also shown is the armature 50 in the far forward position, a fishing pole 60 resting against the gunnel and the heavy lead core fishing line 70 with some slack which is attached to the quick-release mechanism (not shown) of the armature 50.

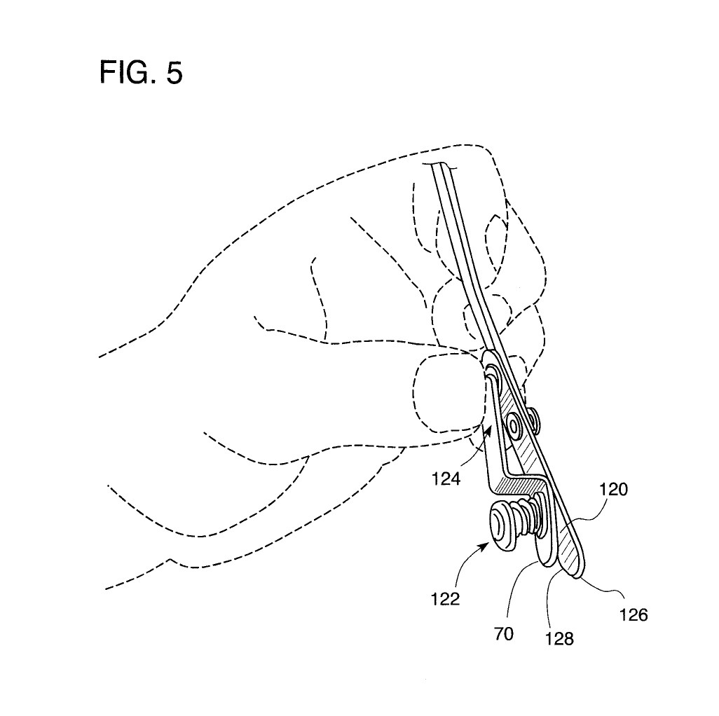

The key to this facet of the invention is that the heavy lead core fishing line that is part of the fishing rod/reel combination must be attached to the armature 50 by means of the force-actuated quick-release mechanism as shown in FIG. 5. As the armature 50 moves, the force-actuated quick-release mechanism holds the lead core line 70 firmly in place with the result being that the lure or bait attached to the bottom of the lead core line 70 moves forward quickly, thereby simulating the darting movement of small fish on the bottom of the lake and thereby attracting the walleye who prey upon the small fish. When a fish strikes at the lure/bait and actually engages the hook and attempts to swim away, the force inherent in the strike causes the force-actuated quick-release mechanism to release the heavy core lead line 70 (which continues to be attached to the fishing rod) and the fisherman brings the walleye in with the fishing rod 60 and reel.

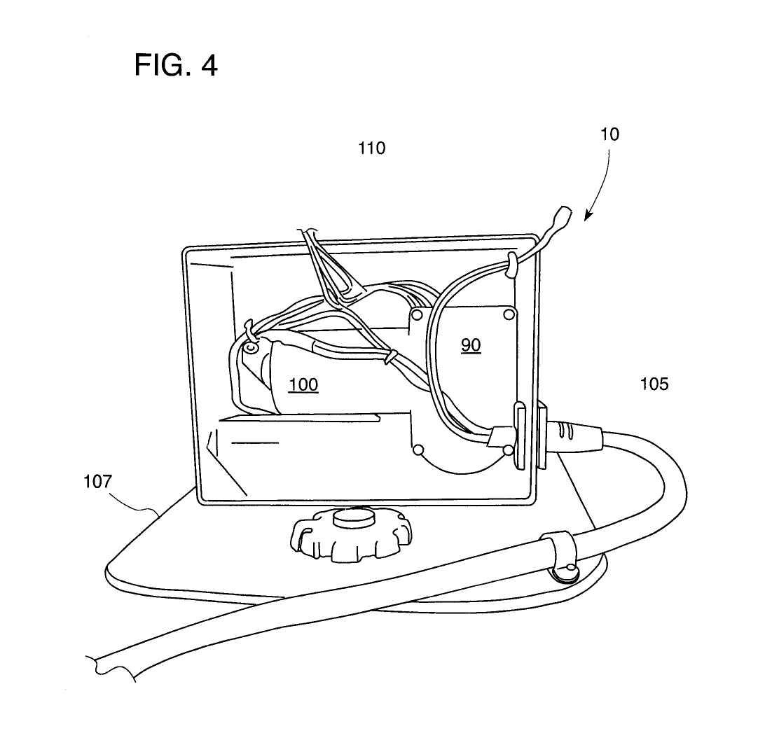

FIG. 4 shows the internals of the central part of the device 10 including the internal cabling 110, control mechanism 90, and the power cord 105 running from the external power source to the electric motor 100. Note that in this view, the cover of the central part of the device is removed to show the internals. In normal operations, a cover is installed over the sensitive electrical and electronic components. Also shown is the base plate of the device which gives the device stability and generally contains means for affixing the device to the gunnels or other parts of the boat.

Referring to FIG. 5 the force-actuated quick-release mechanism 120 that is located at the opposite end of the armature from the motor shaft is shown. Component parts of the force-actuated quick-release mechanism are also shown including the adjustable spring mechanism 122 and compression plate 126 that hold the heavy lead core line to armature and the moment arm 124 of the release mechanism. The mechanism is one of the key elements of the ripping device. The key is to provide enough strength to hold the heavy lead core line in place while the armature-release mechanism combination oscillates back and forth while at the same time allowing the force of a strike and rapid turn away of a walleye to cause the heavy lead core line to disengage from the armature.

The force-actuated quick-release mechanism is utilized in the following manner: the heavy lead core line is loaded into force-actuated quick-release mechanism 120 by depressing the moment arm 124 thereby allowing the aperture or gap 128 between the spring mechanism 122 and the compression plate 126 to form. The heavy lead core line 70 is then placed into the aperture and the moment arm 124 is released, thereby holding the heavy lead core line 70 firmly in place. The thumbwheel on the spring 122 can be rotated to adjust the force with which the line is held in place. The force-actuated quick-release mechanism can either be affixed to the end of the armature in several manners, including without limitation being welded to the armature, utilizing a screw-thread mechanism, or being otherwise clipped to the armature.

There are alternate embodiments of attaching the fishing line ripping device. One alternate embodiment is to use a snap-in wire mechanism such as a cable release clip. This clip is mechanically attached to the armature. Fishing line is wrapped around the open end of the stainless steel wire. The snap-in wire is wedged into the body of the clip. When a fish strikes the baited hook or lure, the snap-in wire disengages and releases the line from the clip. This alternate embodiment retains the characteristic of being pressure sensitive and therefore force actuated.

The following is claimed:

1. An electro-mechanical device used by fisherman to simulate the rapid motion of small fish at or near the bottom of a lake or other body of water comprising the following:
a. a small electric motor and associated power cord,
b. a controller that controls the speed and delay time of the mechanism,
c. an armature fixedly attached at one end to the shaft of the electric motor such that the armature can rotate around the shaft in harmonic motion,
d. a force-actuated quick-release mechanism for attaching fishing line to the armature fixedly attached to the other end of the armature,
e. a housing to enclose the motor, controller and other sensitive electrical and electronic component,
f. a power cord extending attached to the motor and extending through the housing,
g. an adapter plate that allows the entire device to be attached to the gunnels of a boat or other type of vessel, and
h. a power source.

2. A device as in claim 1 where the electric motor is rated at between one quarter and two horsepower;

3. A device as in claim 1 where the armature is between 12 and 36 inches long;

4. A device as in claim 1 where the armature and the force-actuated quick-release mechanism are made of a strong lightweight non-corrosive metal or composite;

5. A device as in claim 1 where the armature partially rotates about the shaft of the motor such that the armature is always between 0 and 180 degrees below the horizontal;

6. A device as in claim 1 where the controller can operate the motor at angular velocities between 0 and 120 revolutions per minute.

7. A device as in claim 1 where the power source is a marine battery.

8. A device as in claim 1 where the delay time is between 1 and 15 seconds.

9. A method for using the device in claim 1 whereby:
a. a fisherman is in a boat that is moving slowly forward with a fishing line rigged to a fishing pole;
b. a hook is baited or a lure is attached at the end of the fishing line;
c. slack fishing line is attached to the force-actuated quick-release mechanism;
d. the controller is adjusted such that the motor rotates at angular velocities between 0 and 120 revolutions per minute;
e. the rotation of the motor shaft causes the armature to rotate around the motor shaft;
f. the motion of the armature causes the fishing line to move forward in short spurts;
g. the motion of the fishing line causes the baited hook or lure to move quickly forward simulating the motion of small fish and thereby attracting larger fish;
h. the larger fish strikes the baited hook or lure, thereby causing the force-actuated quick-release mechanism to release, thereby returning control of the fishing line and baited hook or lure to the fisherman wielding the fishing rod; and
i. the fisherman reels in the fish.

10. A method for using the device in claim 1 as recounted in claim 8 where the fishing line is heavy lead core line or other similar heavy line such that it sinks to the bottom of the body of water.

11. A force-actuated quick-release mechanism comprised of
a. an adjustable spring mechanism,
b. a compression plate,
c. a moment arm, and
d. an aperture formed by depressing the moment arm thereby moving the spring mechanism away from the compression plate, thereby allowing an object to be inserted therein.

12. A force-actuated quick-release mechanism as in claim 8 where the mechanism attaches to an armature.

13. A force-actuated quick-release mechanism as in claim 8 where the object inserted into the aperture is fishing line.

14. A force-actuated quick-release mechanism where fishing line is wrapped around a snap-in wire and the snap-in wire is engaged into the body of the mechanism.
